(19) United States
(12) Patent Application Publication
(10) Pub. No.: US 2024/0241945 A1
(43) Pub. Date: Jul. 18, 2024

(54) SYSTEM AND METHOD FOR CORRELATING ALERTS GENERATED BY ENDPOINTS

(71) Applicant: VMware, Inc., Palo Alto, CA (US)

(72) Inventors: Lalit Prithviraj JAIN, Santa Clara, CA (US); Raghav BATTA, Livermore, CA (US); Jonathan James OLIVER, Kew (AU); Anjali MANGAL, Cupertino, CA (US)

(21) Appl. No.: 18/154,758

(22) Filed: Jan. 13, 2023

(51) Int. Cl. G06F 21/55

(52) U.S. Cl. CPC G06F 21/552; G06F 2221/034

(57) ABSTRACT

A method of correlating alerts that are generated by a plurality of endpoints includes the steps of: collecting alert data of alerts generated by the endpoints; for each endpoint, computing alert sequences based on the collected alert data; training a sequence-based model with the computed alert sequences, to generate a vector representation for each of the alerts; for each alert in a set of alerts generated during a first time period, acquiring a vector representation corresponding thereto, which has been generated by the sequence-based model; and applying a clustering algorithm to the vector representations of the alerts in the set of alerts to generate a plurality of clusters of correlated alerts.

### BACKGROUND

It has become increasingly critical for security systems to generate contextual, timely, and actionable alerts such that security analysts can initiate speedy mitigation measures. Unfortunately, in a typical security operations center, the number of alerts that are generated far outnumber the number of security analysts that can effectively triage them. As a result, critical alerts are often missed by the security analysts due to fatigue and burnout. In addition, many critical alerts are identified too late for mitigation measures to be effective.

Rules are written to trigger the alerts when threat behavior is detected. However, legitimate behavior similar to the threat behavior often occurs in other processes, and this leads to many false alerts being triggered by the rules. Therefore, a customized configuration of the rules is employed to reduce the number of false alerts. As used herein, a false alert is referred to as a “noisy alert” and a positive alert is referred to as an “anomalous alert.”

Even with the reduction of noisy alerts, the mapping of the alerts to actual security threats is not always straightforward or one-to-one, and often security analysts need to undergo a tedious analysis to reach a verdict. In addition, an alert taken individually, without much context, might not be sufficient to qualify as a security threat, whereas a sequence of alerts can indicate a potential security breach. For example, a behavior that triggers an alert may look legit at a first glance, but when it is part of a coordinated activity, the alert may actually signal malware spreading across a network.

### SUMMARY

One or more embodiments provide a technique to correlate alerts generated by a plurality of endpoints. A method of correlating alerts, according to an embodiment, includes the steps of: collecting alert data of alerts generated by the endpoints; for each endpoint, computing alert sequences based on the collected alert data; training a sequence-based model with the computed alert sequences, to generate a vector representation for each of the alerts; for each alert in a set of alerts generated during a first time period, acquiring a vector representation corresponding thereto, which has been generated by the sequence-based model; and applying a clustering algorithm to the vector representations of the alerts in the set of alerts to generate a plurality of clusters of correlated alerts.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtual computing environment which implements a cloud-based security platform according to embodiments.

FIG. 2 is a block diagram that illustrates components of the cloud-based security platform that are employed in correlating alerts according to embodiments.

FIG. 3 is a flow diagram of a method of generating clusters of correlated alerts according to embodiments.

FIG. 4 is a flow diagram of a method of monitoring alerts and selecting a cluster corresponding to the monitored alerts as a target for root cause analysis, according to embodiments.

FIG. 5 is a flow diagram of a method of generating sequences of alerts on which to perform a root cause analysis, according to embodiments.

FIG. 6 is a flow diagram of a recursive function that is called in the method of FIG. 5.

### DETAILED DESCRIPTION

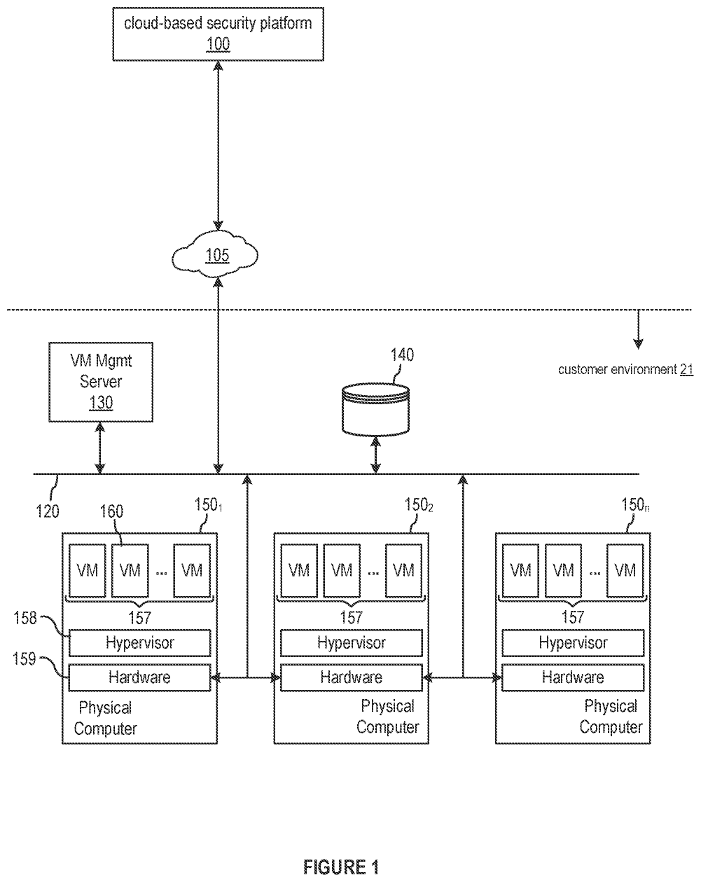

FIG. 1 is a block diagram of a virtual computing environment which is deployed in a customer environment 21 and employs a cloud-based security platform 100, according to embodiments. In the embodiments illustrated herein, virtual computing instances that are provisioned in the virtual computing environment are VMs, and the provisioning of the VMs are managed by a VM management server 130. In some embodiments, virtual computing instances provisioned in the virtual computing environment are containers.

As used herein, a “customer” is an organization that has subscribed to security services offered through cloud-based security platform 100. A “customer environment” means one or more private data centers managed by the customer, which is commonly referred to as “on-prem,” a private cloud managed by the customer, a public cloud managed for the customer by another organization, or any combination of these.

As illustrated in FIG. 1, VMs 157 are deployed on a plurality of physical computers 150₁, 150₂, . . . , 150ₙ, (also referred to as “host computers”), which VM management server 130 manages as a cluster to provide cluster-level functions, such as load balancing across the cluster through VM migration between the hosts, distributed power management, dynamic VM placement according to affinity and anti-affinity rules, and high availability (HA). VM management server 130 also manages a shared storage device 140 and provisions storage resources for the cluster (e.g., one or more virtual disks 141 for each of VMs 157) from shared storage device 140.

Each of the host computers includes a hypervisor 158 (more generally, “virtualization software”) and a hardware platform 159. Hardware platform 159 contains components of a conventional computer system, such as one or more central processing units, system memory in the form of dynamic and/or static random access memory, one or more network interface controllers connected to a network 120, and a host bus adapter connected to shared storage 140. In some embodiments, hardware platform 159 includes a local storage device, such as a hard disk drive or a solid state drive, and the local storage devices of the host computers are aggregated and provisioned as shared storage device 140.

In the embodiments, security services are provided to various security endpoints, which include VMs 157, through a cloud-based security platform 100, which includes a plurality of services and executes a plurality of processes, each of which is running in a container or a VM that has been deployed on a virtual infrastructure of a public cloud computing system. To enable delivery of security services to VMs 157, security agents installed in VMs 157 and the security agents communicate with cloud-based security platform 100 over a public network 105, e.g., the Internet. In one embodiment, these security agents are agents of an endpoint detection and response cloud service, such as one provided by VMware Carbon Black®.

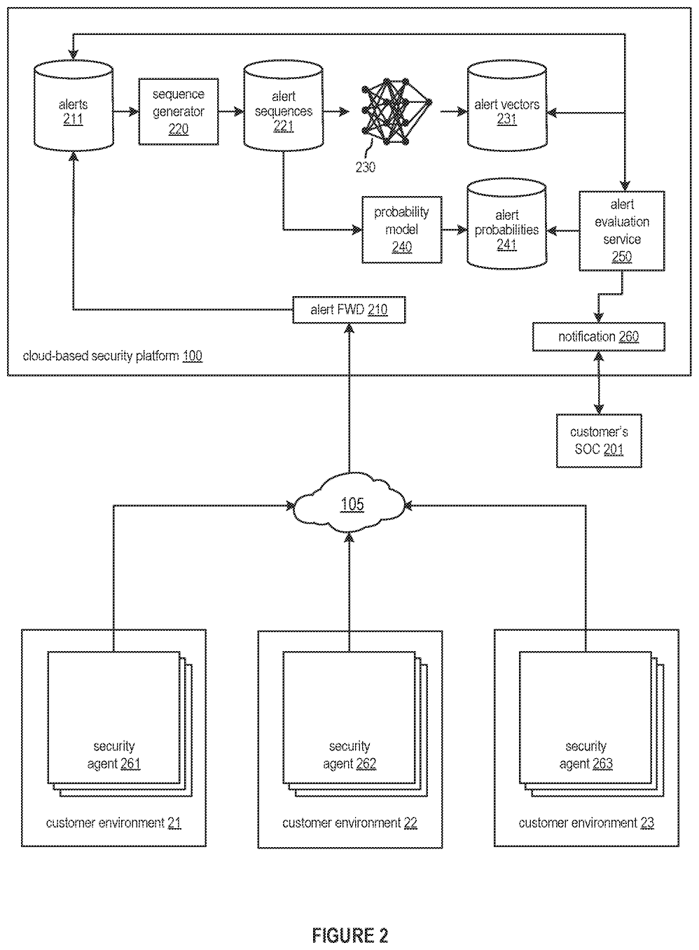

As illustrated in FIG. 2, the services of cloud-based security platform 100 include an alert forwarding service 210, an alert evaluation service 250, and a notification service 260. Cloud-based security platform 100 also maintains several databases in a storage device. They include an alerts database 211, alert sequences database 221, alert vectors database 231, and alert probabilities database 241.

Alert forwarding service 210 routes alerts that are transmitted to cloud-based security platform 100 by security agents installed in VMs that are provisioned in customer environments which employ security services provided by cloud-based security platform 100. In

FIG. 2, three different customer environments, including customer environments 21, 22, 23 depicted in FIG. 1, are shown as an example. The security agents that transmit alerts to cloud-based security platform 100 include security agents 261 that are installed in VMs of customer environment 21, security agents 262 that are installed in VMs of customer environment 22, and security agents 263 that are installed in VMs of customer environment 23.

In the embodiments, each of security agents 261, 262, 263 monitors rules (e.g., watchlist rules) that security domain experts of the corresponding organization have written, and generate alerts when the conditions of any of the rules are satisfied. For example, one rule may specify that any execution of a PowerShell® command-line should be a trigger for an alert. In such a case, each time a PowerShell® command-line is executed in a VM, the security agent installed in the same VM generates a corresponding alert. In addition, the security agents transmit the alerts to cloud-based security platform 100 along with various attributes of the alerts. The attributes of each alert include: (1) timestamp indicating the date and time the alert was generated, (2) device ID of the endpoint (e.g., VM) in which the security agent that generated the alert is installed, (3) organization ID of the organization to which the endpoint belongs, and (4) rule ID that identifies the rule which triggered the alert. Hereinafter, an attribute of an alert which includes its timestamp, device ID, organization ID, and rule ID is referred to as “alert data.” In addition, an alert is identified by the rule ID of the rule that triggered the alert. Therefore, a set of n unique alerts includes a_{1}, a_{2}, a_{3}, . . . , a_{n}, where a_{i} is the rule ID of the rule that triggered the i-th alert in the set, and a sequence of alerts is expressed as a sequence of rule IDs of the alerts.

Alert forwarding service 210 routes the alert data of each alert transmitted thereto (which includes its timestamp, device ID, organization ID, and rule ID) to alerts database 211 for collection therein. Sequence generator 220 is a process running in cloud-based security platform 100 to generate sequences of alerts and store the sequences of alerts in alerts sequences database 221 for training a machine learning model 230 to generate a vector representation for each alert. Machine learning model 230 is another process running in cloud-based security platform 100 and may be any of the well-known sequence-based machine learning models, such as long short-term memory (LSTM) neural networks. Alternatively, machine learning model 230 may be configured to learn vector embedding of each alert based on natural language processing techniques, such as word2vec. The vector representations for the alerts generated by machine learning model 230 are stored in alert vectors database 231.

To compute the sequences of alerts that are stored in alerts sequences database 221, sequence generator 220 separates the alert data stored in alerts database 211 according to the device ID, arranges each separated portion of the alert data as a time series of alerts, and breaks up each time series of alerts into smaller sequences by either: (i) setting a sliding window of a fixed size and applying the sliding window to the time series of alerts to generate the smaller sequences, or (ii) computing time_{thr} as an average time interval between two alerts plus ‘m’ multiple of the standard deviation, σ, of the time interval between two alerts, where m=2 or 3 (i.e., time_{thr}=[average time interval]+m*σ), and breaking up the time series of alerts at locations where two successive alerts are separated by time_{thr} or more.

Sequence generator 220 computes the sequences of alerts in the above manner for all alert data that have been collected over a date range specified, e.g., the last 12 months, for training machine learning model 230. After this training is completed, machine learning model 230 generates and outputs a set of vector representations of the alerts and stores them in alert vectors database 231. In addition, as additional alert data are collected into alerts database 211 continually over time, sequence generator 220 computes new sequences of alerts in the above manner at a predetermined frequency (e.g., once every month) for additional training of machine learning model 230 with the new sequences of alerts. At the completion of each such additional training, machine learning model 230 generates and outputs an updated set of vector representations of the alerts and stores them in alert vectors database 231.

The sequences of alerts stored in alerts sequences database 221 are also supplied to a probability model 240, which is another process running in cloud-based security platform 100. Probability model 240 is configured to generate the following probabilities for each alert, a_{i}, in a set of n alerts, where i=1, 2, . . , n: (1) the probability that alert, a_{i}, appears in the sequences of alerts stored in alerts sequences database 221; and (2) for each alert that is different from alert, a_{i}, the probability that the different alert will follow, directly or indirectly, alert, a_{i}, in the sequences of alerts stored in alerts sequences database 221. In one embodiment, probability model 240 implements any of the well-known techniques that is based on Bayesian probability. The probabilities generated in the above manner by probability model 240 are stored in alert probabilities database 241.

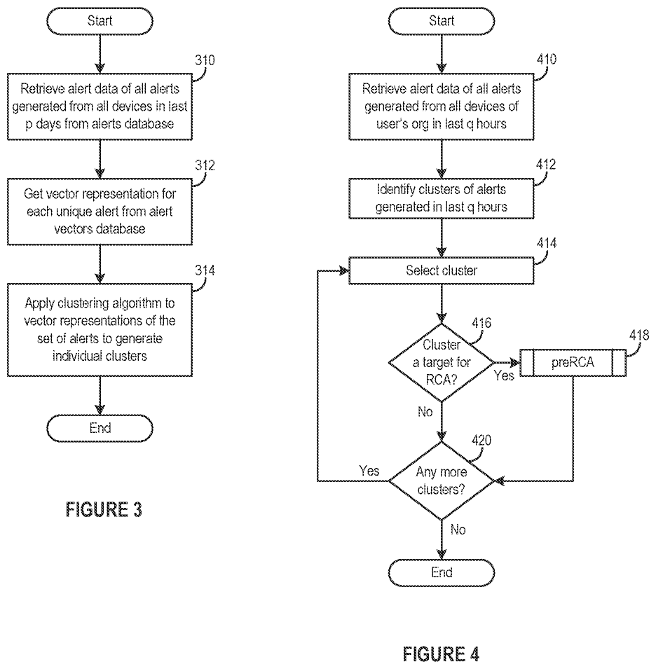

Alert evaluation service 250 consumes the data stored in alerts database 211, alert vectors database 231, and alert probabilities database 241 to carry out the method of generating clusters of correlated alerts, which is depicted in FIG. 3. The method of FIG. 3 begins at step 310 where alert evaluation service 250 retrieves from alerts database 211, alert data of all alerts generated from all devices in the last ‘p’ days, e.g., ‘p’=90. Then, alert evaluation service 250 at step 312 queries alert vectors database 231 for vector representations corresponding to the unique alerts of the alert data retrieved at step 310, and then at step 314 applies a clustering algorithm to the vector representations returned by alert vectors database 231 to generate clusters of correlated alerts. Any of the well-known clustering algorithms, e.g., density-based spatial clustering of applications with noise (DBSCAN), k-means, Gaussian mixture models (GMM), and hierarchical agglomerative clustering (HAC), may be applied.

FIG. 4 is a flow diagram of a method of monitoring alerts of a particular organization and selecting a cluster corresponding to the monitored alerts as a target for root cause analysis. At step 410, alert evaluation service 250 retrieves from alerts database 211, alert data of all alerts generated from all devices of the organization in the last ‘q’ hours, e.g., ‘q’=6, 12, 18, or 24. Then, at step 412, alert evaluation service 250 examines the clusters generated at step 314 to identify the clusters in which the alerts generated from all devices of the organization in the last ‘q’ hours can be found.

After the clusters are identified at step 412, alert evaluation service 250 selects these clusters one-by-one at step 414, and determines whether or not the selected cluster should be a target for root cause analysis at step 416. All clusters previously flagged as being safe are filtered out whereas all clusters previously flagged as malicious are determined to be targets for root cause analysis. For a cluster that has not been previously flagged as either safe or malicious, any of the well-known techniques for determining whether the cluster is potentially malicious or not may be employed, and if determined to be potentially malicious, the cluster becomes a target for root cause analysis. In addition, the number of different devices of the organization that generated the alerts of the cluster and the volume of alerts of the cluster generated by these devices are factors in determining whether or not the cluster should become a target for root cause analysis. In one embodiment, a large deviation from the norm causes the cluster to become a target for root cause analysis.

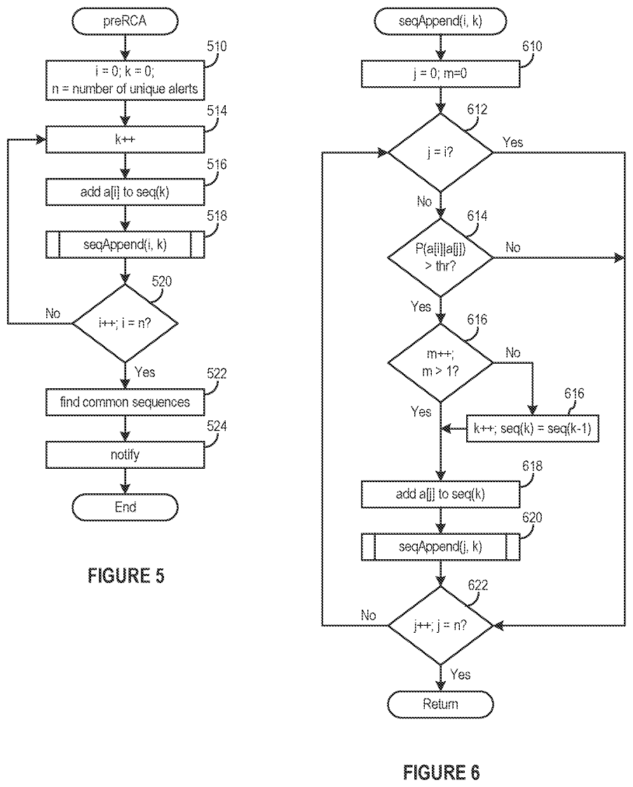

If the cluster becomes a target for root cause analysis (step 416, Yes), alert evaluation service 250 designates the cluster for root cause analysis and executes a process (preRCA) in preparation for the root cause analysis at step 418. Details of preRCA process are described below in conjunction with FIGS. 5 and 6. If the cluster is not a target for root cause analysis (step 416, No), step 420 is executed and thereafter the method either loops back to step 414 or terminates.

Alert evaluation service 250 carries out the steps of FIG. 5 and FIG. 6 on each cluster that is designated for root cause analysis. FIG. 5 is a flow diagram of a method of generating sequences of alerts on which to perform a root cause analysis, according to embodiments. FIG. 6 is a flow diagram of a recursive function that is called in the method of FIG. 5.

At step 510, variables i, k, and n are initialized. Variable i represents a counter for a loop that is executed in the method of FIG. 5 and is initialized to 0. Variable k represents a counter for the number of sequences that are generated by the method of FIGS. 5 and 6 and is initialized to 0. Variable n is set to the number of unique alerts that are generated from all devices of the organization in the last ‘q’ hours and are in the cluster designated for root cause analysis on which the steps of FIG. 5 and FIG. 6 are carried out.

In the method of FIG. 5, the loop is executed for each alert, a[i], in the set of n unique alerts. Then, the variable k is incremented by 1 at step 514 and the alert, a[i], is added to the sequence, seq(k), at step 516. Then, at step 518, a recursive function seqAppend is called with two parameters, i and k. Upon return from the recursive function, at step 520, the variable i is incremented and the method loops back to step 512 if the value of i is not yet equal to the value of n (step 520, No).

If it is determined at step 520 that the value of i is equal to the value of n (step 520, Yes), alert evaluation service 250 examines all of the sequences, seq(1), seq(2), . . . , seq(k), at step 522 to find common sequences containing two or more alerts. At step 524, alert evaluation service 250 notifies SOC 201 of the organization through notification service 260 that the common sequences of two more or alerts found at step 522 need further investigation.

The recursive function of FIG. 6, seqAppend, is executed to either add to the sequence created by the method of FIG. 5 or to create one or more new sequences starting from either the sequence created by the method of FIG. 5 or the one or more new sequences created by the recursive function. The two parameters that the recursive function of FIG. 6 is called with include i and k. The parameter i identifies the alert, a[i], against which each of other alerts, a[j], will be evaluated in the recursive function.

At step 610, variables j and m are initialized. Variable j represents a counter for a loop that is executed in the recursive function and is initialized to 0. Variable m represents a counter for the number of sequences that rely on the sequence, seq(k), as the base sequence. If m=1, a new alert is added to the sequence, seq(k). However, if m>1, a new sequence, seq(k++), is created.

In the recursive function, the loop is executed for each alert, a[j], in the set of n unique alerts, so long as j does not equal i. If j does equal i (step 612, Yes), the variable j increments by one at step 622 and the loop returns to step 612. If j does not equal i (step 612, No), the probability that alert, a[j], will follow alert, a[i], is retrieved from alert probabilities database 241 and compared against the threshold probability at step 614. If the retrieved probability is greater than the threshold probability (step 614, Yes) and the value of m, after being incremented, is still 1 (step 616, Yes), the recursive function at step 618 adds the alert, a[j], to the sequence, seq(k). Then, the recursive function is called at step 620 with the parameters, j and k.

If, at step 616, the value of m, after being incremented, is greater than 1 (step 616, No), the variable k is incremented by one and a new sequence having the incremented k value is created. This new sequence is initially set to have the same sequence of alerts as the prior sequence, seq(k−1). After creation of the new sequence, the recursive function at step 618 adds the alert, a[j], to the new sequence. Then, the recursive function is called at step 620 with the parameters, j and k.

Upon returning from the recursive function call at step 620, the variable j is incremented by 1 at step 622 and the recursive function loops back to step 612 if the value of j is not yet equal to the value of n (step 622, No). On the other hand, if the value of j is equal to the value of n (step 622, Yes), the recursive function returns execution control to the calling function.

In the embodiments, correlated alerts are grouped into individual clusters, and the clusters of correlated alerts are used to: (1) analyze individual clusters, each representing a specific behavior, and determining if that behavior could be malicious or legitimate; (2) find the gravity of a cluster by the number of correlated alerts in the cluster and how many different endpoints have generated alerts that are in the cluster; (3) analyze common sequences of each cluster to determine if the cluster could be malicious or legitimate; (4) label individual clusters as malicious, noisy, or neutral, this label being used to inference whether future alerts could be malicious or are noisy; and (5) perform pattern mining on the clusters to determine which clusters should be a target for root cause analysis.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, NAS, read-only memory (ROM), RAM (e.g., flash memory device), Compact Disk (e.g., CD-ROM, CD-R, or CD-RW), Digital Versatile Disk (DVD), magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, modifications, additions, and improvements may fall within the scope of the appended claims.

What is claimed is:

1. A method of correlating alerts generated by a plurality of endpoints according to sequences in which the alerts were generated, said method comprising:
collecting alert data of alerts generated by the endpoints;
for each endpoint, computing alert sequences based on the collected alert data;
training a sequence-based model with the computed alert sequences, to generate a vector representation for each of the alerts;
for each alert in a set of alerts generated during a first time period, acquiring a vector representation corresponding thereto, which has been generated by the sequence-based model; and
applying a clustering algorithm to the vector representations of the alerts in the set of alerts to generate a plurality of clusters of correlated alerts.

2. The method of claim 1, further comprising:
for a set of new alerts generated during a second time period after the first time period, determining the clusters corresponding to the new alerts and whether or not each of the determined clusters is a target for root cause analysis; and
for each cluster that is determined to be a target for root cause analysis, generating one or more sequences of new alerts and identifying a subset of the generated one or more sequences as alert sequences to be examined during the root cause analysis.

3. The method of claim 2, wherein the generated one or more sequences include a first sequence that contains a first alert followed by a second alert, and the first sequence is generated based on a statistical likelihood of the first alert appearing in the computed alert sequences and a statistical likelihood of the second alert following the first alert in the computed alert sequences.

4. The method of claim 3, wherein the statistical likelihood of the first alert appearing in the computed alert sequences is greater than a threshold probability and the statistical likelihood of the second alert following the first alert is greater than the threshold probability.

5. The method of claim 4, wherein the first sequence further contains a third alert, and the statistical likelihood of the third alert following the second alert in the computed alert sequences is greater than the threshold probability.

6. The method of claim 2, wherein the alerts generated during the first time period are alerts generated by endpoints of a plurality of organizations and the new alerts generated during the second time period are alerts generated by endpoints of one of the organizations.

7. The method of claim 1, wherein the alerts are each identified by an identifier of a watchlist rule associated therewith.

8. A cloud platform for collecting alerts generated by security agents installed in endpoints of a plurality of tenants and generating a plurality of clusters of correlated alerts, the cloud platform comprising:
a data store in which the alerts that are generated by the security agents installed in the endpoints are stored; and
one or more processors programmed to execute the steps of:
for each endpoint, computing alert sequences based on the alerts generated by the endpoint;
training a sequence-based model with the computed alert sequences, to generate a vector representation for each of the alerts;
for each alert in a set of alerts generated during a first time period, acquiring a vector representation corresponding thereto, which has been generated by the sequence-based model; and
applying a clustering algorithm to the vector representations of the alerts in the set of alerts to generate a plurality of clusters of correlated alerts.

9. The cloud platform of claim 8, wherein the steps further comprise:
for a set of new alerts generated during a second time period after the first time period, determining the clusters corresponding to the new alerts and whether or not each of the determined clusters is a target for root cause analysis; and
for each cluster that is determined to be a target for root cause analysis, generating one or more sequences of new alerts and identifying a subset of the generated one or more sequences as alert sequences to be examined during the root cause analysis.

10. The cloud platform of claim 9, wherein the generated one or more sequences include a first sequence that contains a first alert followed by a second alert, and the first sequence is generated based on a statistical likelihood of the first alert appearing in the computed alert sequences and a statistical likelihood of the second alert following the first alert in the computed alert sequences.

11. The cloud platform of claim 10, wherein the statistical likelihood of the first alert appearing in the computed alert sequences is greater than a threshold probability and the statistical likelihood of the second alert following the first alert is greater than the threshold probability.

12. The cloud platform of claim 11, wherein the first sequence further contains a third alert, and the statistical likelihood of the third alert following the second alert in the computed alert sequences is greater than the threshold probability.

13. The cloud platform of claim 9, wherein the alerts generated during the first time period are alerts generated by endpoints of the plurality of tenants and the new alerts generated during the second time period are alerts generated by endpoints of one of the tenants.

14. The cloud platform of claim 8, wherein the alerts are each identified by an identifier of a watchlist rule associated therewith.

15. A non-transitory computer readable medium comprising instructions that are executable in a processor of a computer system to carry out a method of correlating alerts generated by a plurality of endpoints according to sequences in which the alerts were generated, said method comprising:
collecting alert data of alerts generated by the endpoints;
for each endpoint, computing alert sequences based on the collected alert data;
training a sequence-based model with the computed alert sequences, to generate a vector representation for each of the alerts;
for each alert in a set of alerts generated during a first time period, acquiring a vector representation corresponding thereto, which has been generated by the sequence-based model; and
applying a clustering algorithm to the vector representations of the alerts in the set of alerts to generate a plurality of clusters of correlated alerts.

16. The non-transitory computer readable medium of claim 15, wherein the method further comprises:
for a set of new alerts generated during a second time period after the first time period, determining the clusters corresponding to the new alerts and whether or not each of the determined clusters is a target for root cause analysis; and
for each cluster that is determined to be a target for root cause analysis, generating one or more sequences of new alerts and identifying a subset of the generated one or more sequences as alert sequences to be examined during the root cause analysis.

17. The non-transitory computer readable medium of claim 16, wherein the generated one or more sequences include a first sequence that contains a first alert followed by a second alert, and the first sequence is generated based on a statistical likelihood of the first alert appearing in the computed alert sequences and a statistical likelihood of the second alert following the first alert in the computed alert sequences.

18. The non-transitory computer readable medium of claim 17, wherein the statistical likelihood of the first alert appearing in the computed alert sequences is greater than a threshold probability and the statistical likelihood of the second alert following the first alert is greater than the threshold probability.

19. The non-transitory computer readable medium of claim 18, wherein the first sequence further contains a third alert, and the statistical likelihood of the third alert following the second alert in the computed alert sequences is greater than the threshold probability.

20. The non-transitory computer readable medium of claim 16, wherein
the alerts are each identified by an identifier of a watchlist rule associated therewith, and
the alerts generated during the first time period are alerts generated by endpoints of a plurality of organizations and the new alerts generated during the second time period are alerts generated by endpoints of one of the organizations.
